(19) United States
(12) Patent Application Publication
(10) Pub. No.: US 2018/0210871 A1
(43) Pub. Date: Jul. 26, 2018

(54) CLAIM RESOLVING DEVICE

(71) Applicant: INTEGRAL SEARCH INTERNATIONAL LIMITED, Taipei (TW)

(72) Inventor: Hong-Shin TSAI, Taipei (TW)

(73) Assignee: INTEGRAL SEARCH INTERNATIONAL LIMITED, Taipei (TW)

(21) Appl. No.: 15/844,402

(22) Filed: Dec. 15, 2017

(30) Foreign Application Priority Data
Jan. 24, 2017 (TW) 106102569

(51) Int. Cl. G06F 17/27; G06Q 50/18

(52) U.S. Cl. CPC G06F 17/274; G06Q 50/184

(57) ABSTRACT

Disclosed is a claim resolving device that resolves a claim by reading a plurality of original sentences of the claim to separate the claim into a plurality of sectional blocks and then divide each sectional block, comprising an element noun grabbing module, a grouping module and a dividing module.

### FIELD OF THE INVENTION

The present invention relates to a claim processing device, and more particularly relates to a claim resolving device for generating a logically resolved content to help read a claim of a patent.

### BACKGROUND OF THE INVENTION

A claim of a patent is with definitions having a regulated format by which a plurality of definition sentences including element nouns and corresponding interrelationship definitions are defined. An element noun generally is classified as a primary element noun and a secondary element noun. An interrelationship definition can be classified as an interrelationship definition between the main elements, an interrelationship definition between the secondary elements and an interrelationship definition between the main element and the secondary element. In other words, a claim is consisted of a plurality of element nouns and complicated interrelationship definitions. Therefore, for a general reader or even for a professional patent specialist, a patent reading is with substantial difficulty. Furthermore, when a more delicate analysis over a definition of claim is required, the confusion of the complicate claim definition is evitable. A patent reader is usually required aid such as line marking or annotating to obtain a precious comprehension. Therefore, it is inconvenience.

### SUMMARY OF THE INVENTION

Accordingly, one of the objectives of the present invention is to provide a claim resolving device that is capable of resolving a claim of a patent and logically displaying the structure of definitions of the claim in a clear form to help users quickly and clearly understand the definitions of the claim, thereby reducing time spending on patent reading and patent analysis.

In order to overcome the technical problems in prior art, the present invention provides a claim resolving device that resolves a claim having a plurality of original sentences by reading the plurality of original sentences to separate the claim into a plurality of sectional blocks and then divide each sectional block, comprising:

an element noun grabbing module that identifies an element noun of the claim according to a part-of-speech table to grab the element noun and an interrelationship definition of the claim;

a grouping module that groups the plurality of original sentences of the claim into at least one sectional block according to a grouping rule; and

a dividing module that divides each sectional block obtained in the grouping module into the element noun and the interrelationship definition according to a dividing rule,

wherein the dividing rule is related to a relationship of part-of-speech in connection to the element noun and the interrelationship definition defined in the sectional block, and/or is related to a positional relationship in connection to the element noun and the interrelationship definition defined in the sectional block, and/or is related to a relationship of part-of-speech in connection to words defined in the interrelationship definition.

In one embodiment according to the present invention, the grouping rule is used to perform a grouping operation to form groups on a basis of a grouping word defined in a grouping word library, and/or is used to perform the grouping operation on a basis of a sub grouping rule, the sub grouping rule being with regulation that, when one original sentence begins with a target element noun which is a previously-defined element noun, and the target element noun has been defined in another original sentence defined ahead of said one original sentence, said another original sentence being begun with a first defined element noun, such that a position of the target element noun is determined as a beginning position of a group.

In one embodiment according to the present invention, the sub grouping rule regulates that, when one original sentence is found with the grouping word defined in the grouping library, the grouping module determines whether the grouping word in said one original sentence is followed by one previously-defined element noun such that the previously-defined element noun is determined as a target element noun, and then a dividing position of the target element noun is determined when the target element noun is defined as a first-time-defined element noun in a beginning of another original sentence defined ahead of said one original sentence such that the dividing position of the target element noun is used as a beginning of a group.

In one embodiment according to the present invention, the grouping module includes an element-noun-storing sub-module that stores all element nouns defined in beginning of the original sentences so as to use for the determination in the sub grouping rule.

In one embodiment according to the present invention, the dividing rule is used to divide the element noun and the interrelationship definition defined after the element noun in the same original sentence.

In one embodiment according to the present invention, the claim resolving device further comprises a subordinating module that, when a subordinating word defined in a subordinating library is identified, it subordinates a firstly defined element noun defined in beginning of the original sentence after the subordinating word such that the subordinated firstly defined element noun is taken as a subordinated element noun.

In one embodiment according to the present invention, the claim resolving device further comprises a subordinated element noun counting module that counts the number of the subordinating word in the sectional block so as to determine times that the subordinating module is to be performed.

In one embodiment according to the present invention, the claim resolving device further comprises a displaying level determining module that determines a level position of the element noun according to the dividing rule and/or the grouping rule and/or the subordinating rule.

In one embodiment according to the present invention, the claim resolving device further comprises a displaying module that displays the claim processed by the displaying level determining module according to a relationship of level position belonging to the element noun and the interrelationship definition corresponding to the element noun.

In one embodiment according to the present invention, the displaying module uses the same marking expression to display the element noun and/or the interrelationship definition defined in the same level.

In one embodiment according to the present invention, the displaying module uses different marking expressions to display the element noun and/or the interrelationship definition defined in different levels.

In the present invention, a patent claim is resolved by the claim resolving device to obtain the structure of the claim formed by primary element nouns, secondary element nouns and interrelationship definitions, and accordingly display the structure of definitions of the claim with an easy comprehensive form to help users quickly and clearly understand the definitions of the claim so thus reduce time spending on patent reading and patent analysis.

### BRIEF DESCRIPTION OF THE DRAWINGS

FIG. 1 is a claim resolving device according to one embodiment of the present invention.

FIG. 2 is a claim resolving device according to another embodiment of the present invention.

FIG. 3a is a schematic diagram of a dividing rule table.

FIG. 3b is a schematic diagram of a part-of-speech table.

FIG. 4 is a schematic diagram of a claim with element nouns being grabbed.

### DETAILED DESCRIPTION OF THE PREFERRED EMBODIMENTS

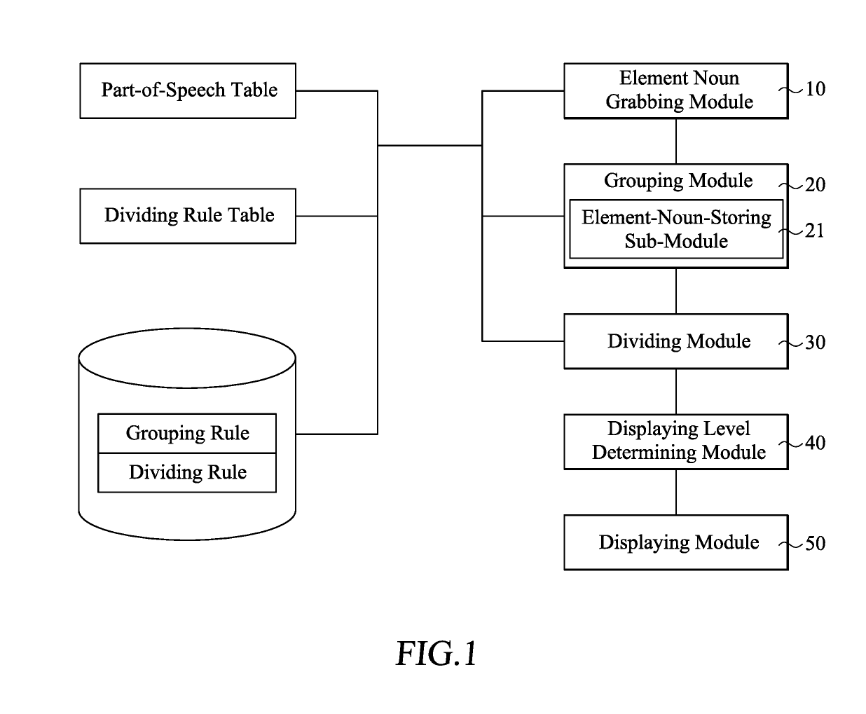

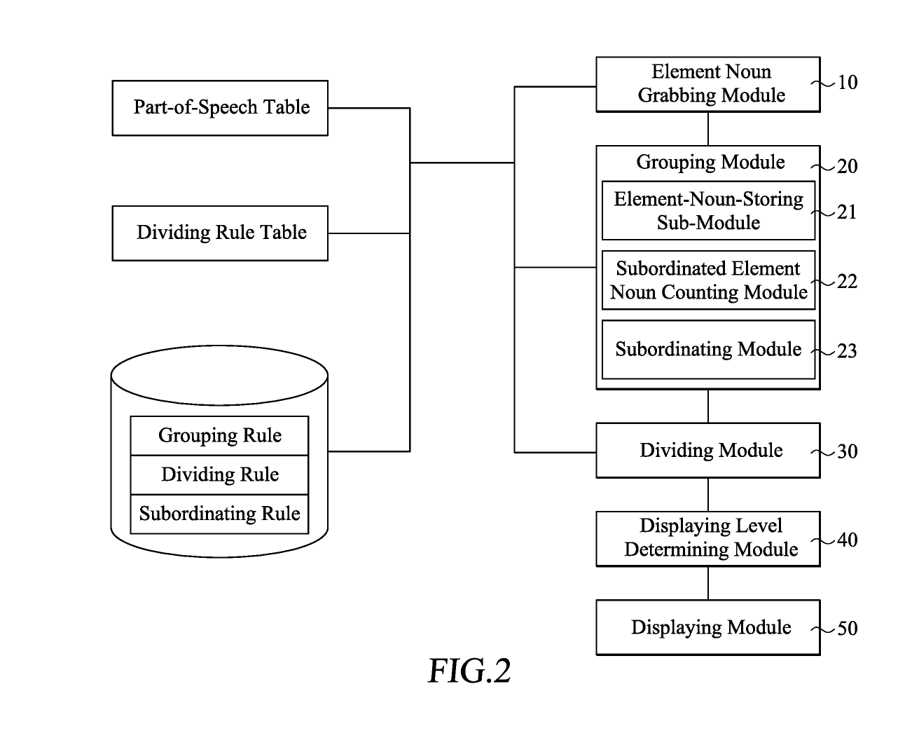

The preferred embodiments of the present invention are described in detail below with reference to FIG. 1 and FIG. 2. The description is used for explaining the embodiments of the present invention only, but not for limiting the scope of the claims.

A claim resolving device according to one embodiment of the present invention is to separate a claim having a plurality of original sentences into a plurality of sectional blocks and then divide each sectional block into individual sentences to obtain the sentences having been resolved.

In one embodiment of the present invention, a claim described below is taken as an example:

“A mounting bracket for a roof window comprising: a frame mountable element disposed on an edge of the roof window; a roof mountable element connected with the frame mountable element; and a hinge element securely connected with a base of the roof mountable element, wherein the hinge element mechanically couples the roof mountable element and the frame mountable element together so that the roof mountable element is movable between an out of use storage position and an in use mounting position.”

Such the example of a claim is not presented with structure and is very difficult in reading.

In the example, the claim includes a plurality of original sentences which are separated from one another by a punctuation mark, that is, a sentence separated from another sentence by a punctuation mark is referred to as an original sentence. For example, “A mounting bracket for a roof window comprising”, “frame mountable element disposed on an edge of the roof window”, “roof mountable element connected with the frame mountable element”, “and hinge element connected with a base of the roof mountable element”, “wherein the hinge element mechanically couples the roof mountable element . . . ”, “wherein the hinge element has a pivotal point locatable between . . . ” and so on are all original sentences.

As shown in FIG. 1 and FIG. 2, the claim resolving device according to the present invention has an element noun grabbing module 10 that identifies an element noun of the claim according to a part-of-speech table to grab the element noun and an interrelationship definition of the claim.

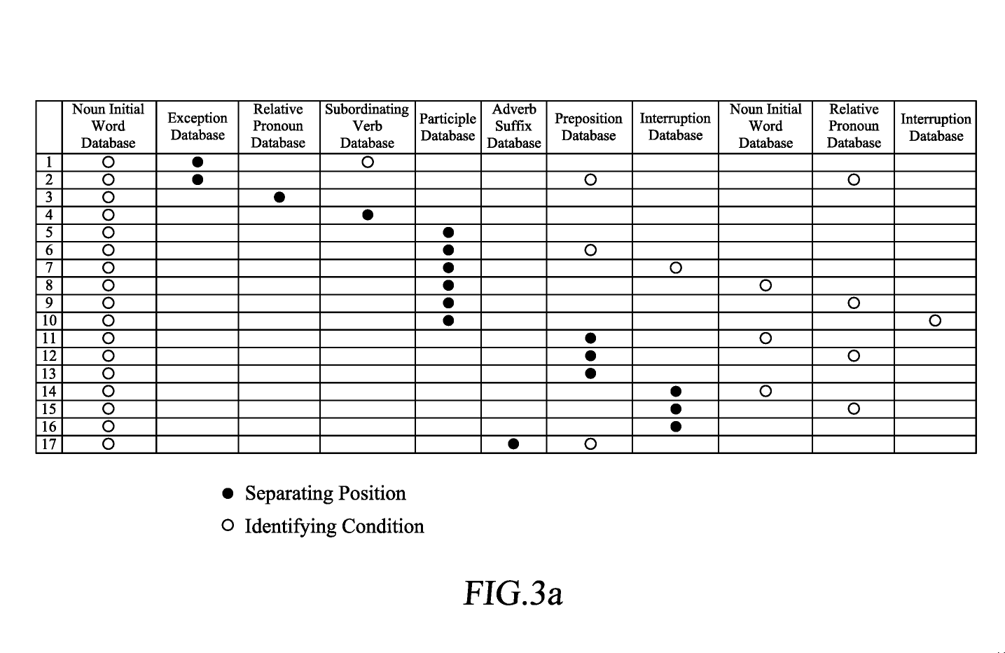

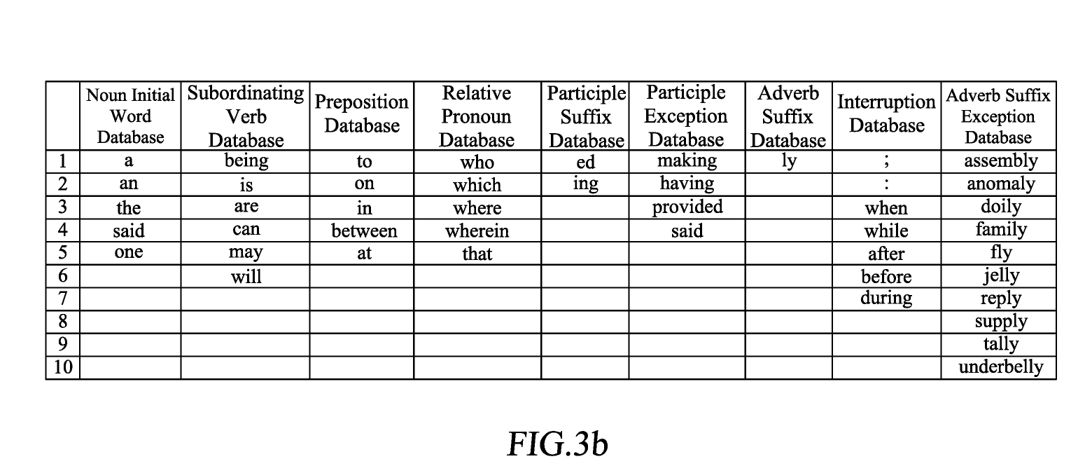

The element noun grabbing module 10 grabs one element noun in the original sentence by identifying the element noun, and grabs the interrelationship definition in the original sentence after grabbing the element noun. The detailed description of performing the element noun grabbing process using the part-of-speech table in FIG. 3b and the dividing rule table in FIG. 3a are explained as followed. Any other detail can be referred to the Taiwan invention patents No. 1537863 and No. 1550422, and is omitted herein. The element noun is grabbed by a processing unit of the element noun grabbing module 10 and is stored in a memory of the element noun grabbing module 10, but is not limited to this. The element noun can be grabbed by a central processing unit or can be stored in any memory of the claim resolving device of the present invention.

In the Taiwan invention patents mentioned above, as shown in FIG. 3a and FIG. 3b, an element noun grabbing module 10 grabs an element noun from the claim according to a part-of-speech word, wherein the part-of-speech word is determined according to a dividing rule table as shown in FIG. 3a and a part-of-speech table as shown in FIG. 3b. The element noun grabbing module 10 grabs the element noun by determining a noun initial word of the claim as a start position of the element noun according to the part-of-speech word, and by determining a final dividing position of the element noun as an end position of the element noun according to the part-of-speech word.

In the Taiwan invention patents mentioned above, the part-of-speech table is a plurality of databases obtained according to the part-of-speech. Referring to FIG. 3b, the plurality of databases include, for example, a noun initial word database, a subordinating verb database, a preposition database, a relative pronoun database, a participle suffix database, an adverb suffix database and an exception database. The part-of-speech identification is with advantage that only very few words or even only some letters of a single word are required to be identified, whereas the part-of-speech identification is performed by applying several relatively limited number of words or partial form defined in the noun initial word database (“a”, “an”, “the”, “said”, “one” and “each”), the subordinating verb database (“being”, “is”, “are”, “can”, “may”, “will”, “comprises”, “comprising”, “includes”, “including”, “has”, “have” and “having”), the preposition database (“to”, “from”, “in”, “on”, “with”, “between”, “at”, etc.), the relative pronoun database (“who”, “which”, “that”, “wherein”, “where”, etc.), a participle suffix database (“-ing” and “-ed”)and an adverb suffix database (“-ly”), and also a participle exception database (“making”, “having”, “provided” and “said”) and adverb suffix exception database (“assembly”, “anomaly”, “doily”, “family”, “fly”, “jelly”, “reply”, “supply”, “tally” and “underbelly”). In other words, a part-of-speech identification is performed by reading a word of patent's claim so as to identify to which database the read word belongs, and thereafter the element noun is concluded by determining a start position of an element noun and an end position of the element noun, i.e., separating position, according to a dividing rule table (FIG. 3a). The element noun is defined as a noun in the claim. The part-of-speech identification is performed by a processing unit of the element noun grabbing module 10 and the result is stored in a memory of the element noun grabbing module 10, but is not limited to this. The part-of-speech identification can be performed by a central processing unit or can be stored in any memory of the claim resolving device of the present invention.

In the Taiwan invention patents mentioned above, an example is a sentence in English as follows.

“a circuit board provided with edges extending in a longitudinal direction of said circuit board”

The below explains how the above sentence is read by referring to the dividing rule table of FIG. 3a so as to describe how the element noun is grabbed. When a sentence reading starts from the beginning of the sentence to read [a] as follows: “[a] circuit board provided with edges extending in a longitudinal direction of said circuit board;” where a word bracketed within “[” and “]” is the word being read. The word [a] is recognized as belonging to “noun initial word database”. Therefore, the marks of “◯” in the second column of FIG. 3a are taken in consideration. Then, the sentence reading goes continued and read [circuit] as follows: “a [circuit] board provided with edges extending in a longitudinal direction of said circuit board;” where “circuit” is recognized as not belonging to any database. Therefore, the sentence reading goes continued and read [board] as follows: “a circuit [board] provided with edges extending in a longitudinal direction of said circuit board;” where “board” is also recognized as not belonging to any database. Then the sentence reading goes continued and read [provided] as follows: “a circuit board [provided] with edges extending in a longitudinal direction of said circuit board;” where “provided” is recognized as belonging to a participle database. The recognition drives the processes to be one of process with numbers from 5 to 10 as indicated by “●” in FIG. 3a. The marks “●” indicates as a temporary separating position. The temporary separating position is a temporary position which will be determined as a separating position when the word following the temporary separating position is determined as a determination word as marked with “◯”. Then the sentence reading goes continued and read [with] as follows: “a circuit board provided [with] edges extending in a longitudinal direction of said circuit board;” where “with” is recognized as belonging to a preposition database such that, according to the dividing rule table, the process of number 6 is selected by determining the recognized word “with” as a determination word and the temporary separating word “provided” is then determined as a separating word to determine an element noun. Accordingly, the element noun is obtained by grabbing words from the noun initial word to the word neighboring to and before the separating word. In the example, the element noun “a circuit board” is grabbed. The sequential reading of claim is performed by a processing unit of the element noun grabbing module 10 and the result is stored in a memory of the element noun grabbing module 10, but is not limited to this. The sequential reading of claim can be performed by a central processing unit or can be stored in any memory of the claim resolving device of the present invention.

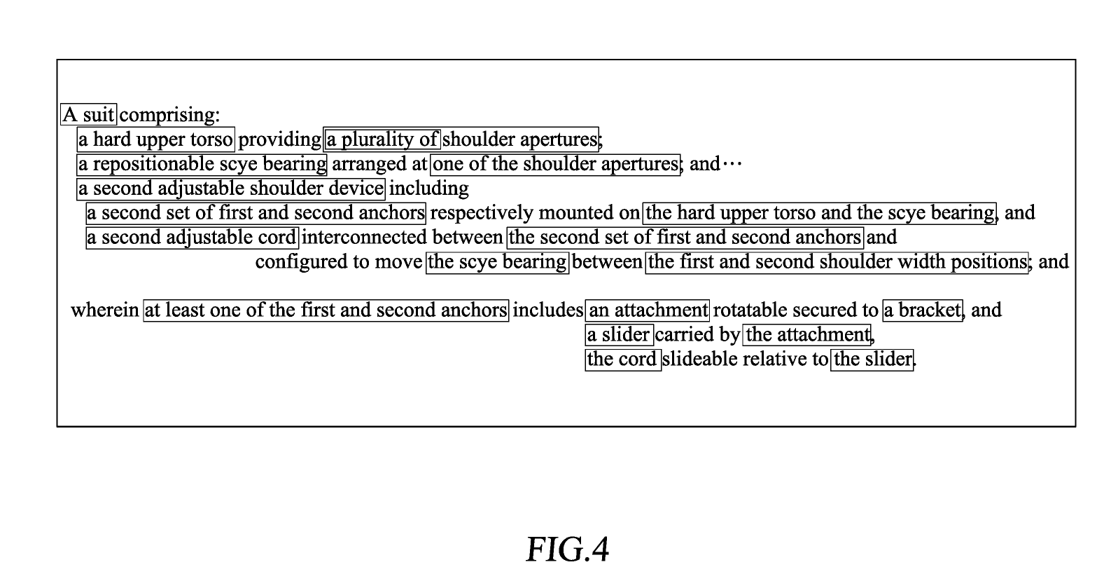

In the Taiwan invention patents mentioned above, FIG. 4 is a diagram showing element nouns grabbed in a claim. The grabbed element nouns are marked by being positioned in the blocks. More specifically, the element nouns are grabbed from the claim according to the part-of-speech table and the dividing rule table, including element nouns of “a suit”, “a hard upper torso”, “a plurality of shoulder apertures”, “a repositionable scye bearing”, “one of the shoulder apertures”, “a second adjustable shoulder device”, “a second set of first and second anchors”, “the hard upper torso and the scye bearing”, “a second adjustable cord”, “the second set of first and second anchors”, “the scye bearing”, “at least one of the first and second anchors”, “an attachment”, “a slider”, “the attachment”, “the cord” and “the slider” in a claim. After the element nouns have been grabbed, a definition content between two neighboring element nouns is defined as an interrelationship definition.

Taking another claim as an example in follows.

“A mounting bracket for a roof window comprising: a frame mountable element disposed on an edge of the roof window; a roof mountable element connected with the frame mountable element; and a hinge element securely connected with a base of the roof mountable element, wherein the hinge element mechanically couples the roof mountable element and the frame mountable element together so that the roof mountable element is movable between an out of use storage position and an in use mounting position.”

After processed, element nouns of “mounting bracket” and “roof window” are grabbed from the original sentence of “A mounting bracket for a roof window comprising”, and an interrelationship definition of “comprising” is grabbed as a subordinating word in the subordinating verb database. In addition, in order to more accurately grab the element noun, when one element noun is separated from another element noun by a preposition of “of”, the two element nouns can be connected together to form one element noun. For example, for a sentence of “a frame mountable element of a mounting bracket”, after element nouns of “a frame mountable element” and “a mounting bracket” are grabbed, an element noun of “a frame mountable element of a mounting bracket” can be obtained by connecting the two element nouns together via the preposition of “of”.

After the whole claim is processed, the element nouns which are identified and obtained by the element noun grabbing module 10 are underlined as follows:

“A mounting bracket for a roof window comprising: a frame mountable element disposed on an edge of the roof window; a roof mountable element connected with the frame mountable element; and a hinge element securely connected with a base of the roof mountable element, wherein the hinge element mechanically couples the roof mountable element and the frame mountable element together so that the roof mountable element is movable between an out of use storage position and an in use mounting position.”

The portion other than the obtained grabbed element nouns as described above is referred to as the interrelationship definition. From the above example, the interrelationship definitions of “comprising”, “disposed on”, “connected with”, “mechanically couples”, “together so that” and “is movable between” are obtained from the respective original sentences. The grabbing of the element nouns and the interrelationship definitions is performed by a processing unit of the element noun grabbing module 10 and the result is stored in a memory of the element noun grabbing module 10, but is not limited to this. The grabbing of the element nouns and the interrelationship definitions can be performed by a central processing unit or can be stored in any memory of the claim resolving device of the present invention.

Further, the claim resolving device 1 according to the present invention has a grouping module 20 that groups the plurality of original sentences of the claim into at least one sectional block according to a grouping rule. The grouping rule is used to perform a grouping operation on a basis of a grouping word defined in a grouping word library, and/or is used to perform the grouping operation on a basis of a sub grouping rule. The sub grouping rule is with regulation that, when one original sentence begins with a target element noun which is a previously-defined element noun, and the target element noun has been defined in another original sentence defined ahead of said one original sentence, said another original sentence being begun with a first defined element noun, such that a position of the target element noun is determined as a beginning position of a group. The grouping operation is performed by a processing unit of a grouping module 20 and the result is stored in a memory of the element noun grabbing module 10, but is not limited to this. The grouping can be performed by a central processing unit or can be stored in any memory of the claim resolving device of the present invention.

The grouping word library in the grouping rule of the grouping module 20 includes the grouping words such as “wherein”, “characterized by that”, “characterized in that” and “comprising:”. When the grouping word of “wherein” is taken as an example, one original sentence beginning with the grouping word of “wherein” is divided from other original sentences defined ahead of said one original sentence. For the grouping words including “wherein”, “characterized by that” and “characterized in that”, the grouping word of “wherein” is taken as a beginning of a new sectional block, and the grouping words of “comprising”, “characterized by that” and “characterized in that” are taken as an end of a new sectional block. As a result, the following sectional blocks are obtained: “A mounting bracket for a roof window comprising:”, “a frame mountable element disposed on an edge of the roof window; a roof mountable element connected with the frame mountable element; and a hinge element securely connected with a base of the roof mountable element,”, and “wherein the hinge element mechanically couples the roof mountable element and the frame mountable element together so that the roof mountable element is movable between an out of use storage position and an in use mounting position.”.

That is to say, the original content has been grouped into three sectional blocks as follows:

“A mounting bracket for a roof window, comprising: “(block 1)

“a frame mountable element disposed on an edge of the roof window; a roof mountable element connected with the frame mountable element; and a hinge element securely connected with a base of the roof mountable element, “(block 2)

“wherein the hinge element mechanically couples the roof mountable element and the frame mountable element together so that the roof mountable element is movable between an out of use storage position and an in use mounting position.” (block 3)

The grouping module 20 can perform the operation of grouping for original content which is not with the grouping word of “wherein”. For a claim not having the term “wherein”, the grouping rule is applied to perform the grouping operation on a basis of a sub grouping rule. The sub grouping rule is applied to determine whether one original sentence begins with word of “,the”, “,said”, “‘(Line Feed)’,the”, “‘(Line Feed)’,said” or not. In other words, the sub grouping rule is applied to determine whether the following is true: one original sentence begins with a target element noun which is a previously-defined element noun, and the target element noun has been defined in another original sentence defined ahead of said one original sentence, said another original sentence being begun with a first defined element noun, such that a position of the target element noun is determined as a beginning position of a group. The first defined element noun is an element noun beginning with “a” or “an”. The previously-defined is an element noun beginning with “the” or “said”. In order to achieve this goal, when “comprising” is identified, the element nouns subordinating to the “comprising” such as primary element noun and secondary element nouns are stored by an element-noun-storing sub-module 21 such that the stored element nouns can be used to determine whether the previously-defined word has been defined in another previous original sentence of the element noun and said previous original sentence is begun with “a” or “an”. The element noun storing operation is performed by a processing unit of the element-noun-storing sub-module 21 and is stored in a memory of the element-noun-storing sub-module 21, but is not limited to this. The operation can be performed by a central processing unit or can be stored in any memory of the claim resolving device 1 of the present invention.

The example that the grouping module 20 can perform the operation of grouping for original content which is not with the grouping word of “wherein” is as follows:

“A mounting bracket for a roof window comprising: a frame mountable element disposed on an edge of the roof window; a roof mountable element connected with the frame mountable element; and a hinge element securely connected with a base of the roof mountable element, the roof mountable element being provided with a direction guiding item which is configured to direct an opening direction of the frame mountable element.”,

As we can see, the underlined portion “, the roof mountable element being provided with a direction guiding item which is configured to direct an opening direction of the frame mountable element.” is defined as beginning with “,” followed by a previously-defined element noun, i.e., an element noun beginning with “the” such that “the roof mountable element” is determined as a target element noun. Accordingly, the target element noun is further determined whether the target element noun has been defined in another original sentence defined ahead of said one original sentence, said another original sentence being begun with a first defined element noun, such that a position of the target element noun is determined as a beginning position of a group. Accordingly, the grouping module 20 has found that “a roof mountable element” has been defined in “a roof mountable element connected with the frame mountable element”, which is another original sentence defined ahead of said one original sentence, said another original sentence being begun with a first defined element noun, so the beginning position of the target element noun of “the roof mountable element” is determined as a sectioning position of a sectional block, thereby obtaining the following result:

“A mounting bracket for a roof window comprising:

a frame mountable element disposed on an edge of the roof window; a roof mountable element connected with the frame mountable element; and a hinge element securely connected with a base of the roof mountable element,

the roof mountable element being provided with a direction guiding item which is configured to direct an opening direction of the frame mountable element.”

In other words, the sentence “the roof mountable element being provided with a direction guiding item which is configured to direct an opening direction of the frame mountable element.” is grouped as another group.

In the present invention, in order to secure the correction of “the element which is firstly defined” and “the element which has been previously-defined” that will be applied in the sub grouping rule, the grouping module 20 according to the present invention can further include an element-noun-storing sub-module 21 that stores all element nouns defined in beginning of the original sentences so as to achieve the goal of the above determination in the sub grouping rule. That is to say, after the element nouns (including “a frame mountable element”, “a roof mountable element” and “a hinge element) subordinating to the grouping word of “comprising” are identified, these three element nouns will be stored in the element-noun-storing sub-module 21 so as to perform the determination of whether the target element noun is an element noun being previously-defined. The present invention is not limited to this. The element-noun-storing sub-module 21 can store all element nouns including a primary element noun and a secondary element noun defined in the original sentences. The element noun storing operation is performed by a processing unit of the element-noun-storing sub-module 21 and is stored in a memory of element-noun-storing sub-module 21, but is not limited to this. The operation can be performed by a central processing unit or can be stored in any memory of the claim resolving device 1 of the present invention.

Moreover, in order to enhance the determination efficiency of sub grouping rule, a grouping word of “comprising” is applied such that when the grouping word of “comprising” is identified, “an element noun collecting process” is performed so as to collect all element nouns according to a punctuation mark and/or “a firstly defined element noun being defined in the beginning of the original sentence”.

That is to say, when “comprising” is identified, “;” is used as a sectioning position of an element noun and/or firstly defined element nouns defined in the beginning of the original sentences are collected. Accordingly, element noun subordinating to “comprising” are collected. The example thereof is as follows:

“A mounting bracket for a roof window comprising: a frame mountable element disposed on an edge of the roof window; a roof mountable element connected with the frame mountable element; and a hinge element securely connected with a base of the roof mountable element, . . . ”.

We can see that when “comprising” is identified, “;” is used as a sectioning position and firstly defined element nouns including a frame mountable element, a roof mountable element and a hinge element defined in the beginning of the original sentence are collected such these three element nouns subordinating to “comprising” are obtained. By means of collecting of the element nouns subordinating to “comprising”, a dividing point of the sectional block can be further identified. The element nouns subordinating to “comprising” are obtained by use of “; a”.

Next, a dividing module 30 of the claim resolving device 1 according to the present invention is described below. The dividing module 30 divides one sectional block obtained in the grouping module 20 into the element noun and the interrelationship definition according to a dividing rule, and the dividing rule is related to a relationship of part-of-speech in connection to the element noun and the interrelationship definition defined in the sectional block, and/or is related to a positional relationship in connection to the element noun and the interrelationship definition defined in the sectional block, and/or is related to a relationship of part-of-speech in connection to words defined in the interrelationship definition. The dividing operation is performed by a processing unit of the dividing module 30 and is stored in a memory of dividing module 30, but is not limited to this. The operation can be performed by a central processing unit or can be stored in any memory of the claim resolving device 1 of the present invention.

The sectional blocks obtained in the grouping module 20 are shown as follows:

“A mounting bracket for a roof window comprising:

a frame mountable element disposed on an edge of the roof window;

a roof mountable element connected with the frame mountable element; and

a hinge element securely connected with a base of the roof mountable element,”.

As we can see, the dividing module 30 divides each sectional block obtained in the grouping module 20 based on a principle that “the element noun and the interrelationship definition are divided from each other”, wherein the related element nouns of “a frame mountable element”, “a roof mountable element” and “a hinge element” are divided from the correspondence interrelationship definition as follows:
“a frame mountable element
   disposed on an edge of the roof window;”,
“a roof mountable element
   connected with the frame mountable element; and”, and
“a hinge element
   securely connected with a base of the roof mountable element,”.

For the purpose of comparison, the original claim and the claim processed by the claim resolving device according to the present invention are separately as follows:

The original claim:

“A mounting bracket for a roof window comprising: a frame mountable element disposed on an edge of the roof window; a roof mountable element connected with the frame mountable element; and a hinge element securely connected with a base of the roof mountable element, wherein the roof mountable element being provided with a direction guiding item which is configured to direct an opening direction of the frame mountable element.”

The claim processed by the claim resolving device:

“A mounting bracket for a roof window, comprising:
a frame mountable element
   disposed on an edge of the roof window;
a roof mountable element
   connected with the frame mountable element; and
a hinge element
   securely connected with a base of the roof mountable element,
      wherein the roof mountable element
being provided with a direction guiding item
   which is configured to direct an opening direction of the frame mountable element.”

The processed claim obtained by the claim resolving device mentioned above can be observed as having advantages of easy reading and easy outlining.

It is noted that only the primary element noun is divided with the corresponding interrelationship definition. The secondary element noun is not divided from the corresponding interrelationship definition. The primary element noun and the secondary element noun are determined according to a positional relationship in connection to the element noun and the interrelationship definition. Other dividing criterion includes a relationship of part-of-speech in connection to words defined in the interrelationship definition.

For example,
“a hinge element
   securely connected with a base of the roof mountable element,”

We can see that the secondary element noun of “a base of the roof mountable element” is not divided from the interrelationship definition of “securely connected with”.

The criterion of “A relationship of part-of-speech in connection to words defined in the interrelationship definition” indicates that the interrelationship definition will be divided according to part-of-speech. For example,

“the roof mountable element being provided with a direction guiding item which is configured to direct an opening direction of the frame mountable element.”

can be divided into:
“the roof mountable element” (a primary element noun)
   “being provided with a direction guiding item which is configured to direct an opening direction of the frame mountable element.”. (an interrelationship definition)

It is noted that, in the interrelationship definition of “being provided with a direction guiding item which is configured to direct an opening direction of the frame mountable element.”, the definition of “which is configured to direct an opening direction of the frame mountable element.” is not divided from “being provided with a direction guiding item” so as to maintain the fluent sentences. This is because the dividing is determined by part-of-speech of word in the interrelationship definition such as the relative pronoun of “which”. On the other hand, while the word “when” is a word that is read to optionally divide or not divide, the dividing module 30 can optional divide or not divide if the word “when” is read.

The dividing rule is used to divide the element noun and the interrelationship definition defined after the element noun in the same original sentence. That is to say, in an original sentence, an element noun is divided from the interrelationship definition following the element noun. In other words, the element noun is divided from the interrelationship definition defined after the element noun.

It is noted that sometimes “comprising” is not with only one form of “comprising: . . . ; . . . ; and . . . ”. Another form includes one that some other complement description (formed by an element noun and an interrelationship definition) is defined between element nouns, i.e., a complement description of a first element is defined between the first element and a second element. That causes a difficulty to identify the definition scope subordinating to “comprising”. As shown in FIG. 2, the grouping module 20 in the present invention further includes a subordinating module 23 that, when a subordinating word defined in a subordinating library is identified, firstly defined element nouns defined in beginning of one original sentence after the subordinating word are collected such that the collected firstly defined element nouns are taken as subordinated element nouns thereby obtaining element nouns defined by “comprising”. As mentioned above, the grouping rule in the grouping module 20 can apply a grouping word such as “comprising” as defined in the grouping library to perform the operation of determination. In other words, when “comprising” is identified, “an element noun collecting process” is performed by collecting firstly defined element nouns defined in beginning of one original sentence after the subordinating word when “,a”, i.e., a punctuation mark followed by a character of “a”, is read such that the collected firstly defined element nouns are taken as subordinated element nouns. The above is the element noun collecting process that performs a collection of element nouns by applying “a firstly defined element noun defined in beginning of one original sentence”. The subordinating operation is performed by a processing unit of the subordinating module 23 and is stored in a memory of subordinating module 23, but is not limited to this. The operation can be performed by a central processing unit or can be stored in any memory of the claim resolving device 1 of the present invention.

As shown in FIG. 2, the grouping module 20 in the present invention further includes a subordinated element noun counting module 22 that counts the number of the subordinating words in the sectional block so as to determine how many times that the subordinating operations are to be performed. Since, one primary element noun may further be defined with one secondary element noun belonging to the primary element noun by using a subordinating word, i.e., comprising. Therefore, the grouping module 20 should determine which element nouns are belonged to which subordinating words when there are a plurality of element nouns. For example,

“A mounting bracket for a roof window comprising:

a frame mountable element comprising an edge portion, a front portion opposed to the edge portion, and an end portion;

a roof mountable element . . . ; and

a hinge element . . . ,”.

In the above example, the element nouns of “a frame mountable element”, “a roof mountable element” and “hinge element” should be classified as belonging to “A mounting bracket”. And the element nouns of “an edge portion”, “a front portion” and “an end portion” should be classified as belonging to “a frame mountable element”. Therefore, it is necessary to provide a subordinated element noun counting module 22 that counts the number of the subordinating words in the sectional block so as to determine how many times that the subordinating operations should perform so as to respectively subordinate the element nouns to respective subordinating words. The subordinated element noun counting operation is performed by a processing unit of the subordinated element noun counting 22 and is stored in a memory of subordinated element noun counting 22, but is not limited to this. The operation can be performed by a central processing unit or can be stored in any memory of the claim resolving device 1 of the present invention.

As shown in FIG. 1 and FIG. 2, the present invention further provides a displaying level determining module 40 that determines level positions of the element nouns according to the dividing rule and/or the grouping rule and/or the subordinating rule. The dividing rule or the grouping rule or the subordinating rule can determine level positions of interrelationship definitions in an original sentence to which an element noun belongs according to the levels of the element nouns. An example is as follows:

“A mounting bracket for a roof window comprising:

a frame mountable element disposed on an edge of the roof window;

a roof mountable element connected with the frame mountable element; and

a hinge element securely connected with a base of the roof mountable element,

wherein the hinge element mechanically couples the roof mountable element and the frame mountable element together so that the roof mountable element is movable between an out of use storage position and an in use mounting position.”.

Since the element nouns of “a frame mountable element”, “a roof mountable element” and “a hinge element” which are belonged to “A mounting bracket” have been subordinated to “A mounting bracket” by using the subordinating word, the element nouns of “a frame mountable element”, “a roof mountable element” and “a hinge element” are determined to have the same level position. Similarly the interrelationship definitions including “disposed on an edge of the roof window”, “connected with the frame mountable element” and “securely connected with a base of the roof mountable element” which are corresponding to the element nouns are determined to have the level positions of their corresponding element nouns. Besides, since “wherein the hinge element mechanically couples the roof mountable element and the frame mountable element together so that the roof mountable element is movable between an out of use storage position and an in use mounting position.” is determined as another sectional block, the beginning of this original sentence is determined as in front most level position. The displayed result is as follows:

“A mounting bracket for a roof window comprising:
a frame mountable element
   disposed on an edge of the roof window;
a roof mountable element
   connected with the frame mountable element; and
a hinge element securely
   connected with a base of the roof mountable element,
wherein the hinge element
   mechanically couples the roof mountable element and the frame mountable element together so that the roof mountable element is movable between an out of use storage position and an in use mounting position.”.

The present invention further includes a displaying module 50 that displays the claim processed by the displaying level determining module 40 according to a relationship of level position belonging to the element noun and the interrelationship definition corresponding to the element noun. In the example mentioned above, the element nouns of “a frame mountable element”, “a roof mountable element” and a “hinge element securely” which have the same level position are determined to have the same indent at the beginning thereof. The displaying operation is performed by a processing unit of the displaying module 50 and is stored in a memory of displaying module 50, but is not limited to this. The operation can be performed by a central processing unit or can be stored in any memory of the claim resolving device 1 of the present invention. The displaying level determining operation is performed by the displaying level determining module 40 and is stored in a memory of displaying level determining module 40, but is not limited to this. The operation can be performed by a central processing unit or can be stored in any memory of the claim resolving device 1 of the present invention.

In addition, the displaying module 50 may use the same marking symbol to mark the element nouns and/or the interrelationship definitions defined in the same level by marking at a position of the element noun itself or a position placed ahead or after the element noun. The displaying module 50 may use different marking symbols to mark the element nouns and/or the interrelationship definitions defined in different levels by marking at a position of the element noun itself or a position placed before or after the element noun. The marking symbols include a black star symbol (i.e., “★”), a numeral surrounded by braces/square brackets/round brackets, uppercase English words, lowercase English words, roman numerals, bold characters, an underline, italicized characters, background colors, font colors, font sizes, or combinations thereof. Taking the above as an example, “a number surrounded by square brackets” marked with bold type and an underline is taken as a marking symbols to place ahead of the element nouns of “a frame mountable element”, “a roof mountable element” and “a hinge element securely” since these three element nouns are defined with the same level. Furthermore, the important words including subordinate verbs, such as “comprising”, “including” and “wherein” are displayed with underline and with bold and italics type. The subordinate verb is surrounded by two tildes (“˜”). And, different background colors (for example, orange and green) are used to display the element nouns in different levels (for example, “a mounting bracket” and “a frame mountable element”). The result is shown as follows:

The above description is only an explanation of the preferred embodiments of the present invention. One having ordinary skill in the art can make various modifications according to the above description and the claims defined below. However, those modifications shall still fall within the scope of the present invention.

What is claimed is:

1. A claim resolving device that resolves a claim having a plurality of original sentences by reading the plurality of original sentences to separate the claim into a plurality of sectional blocks and then divide each sectional block, comprising:
an element noun grabbing module that identifies an element noun of the claim according to a part-of-speech table to grab the element noun and an interrelationship definition of the claim;
a grouping module that groups the plurality of original sentences of the claim into at least one sectional block according to a grouping rule; and
a dividing module that divides each sectional block obtained in the grouping module into the element noun and the interrelationship definition according to a dividing rule,
wherein the dividing rule is related to a relationship of part-of-speech in connection to the element noun and the interrelationship definition defined in the sectional block, and/or is related to a positional relationship in connection to the element noun and the interrelationship definition defined in the sectional block, and/or is related to a relationship of part-of-speech in connection to words defined in the interrelationship definition.

2. The claim resolving device as claimed in claim 1, wherein the grouping rule is used to perform a grouping operation to form groups on a basis of a grouping word defined in a grouping word library, and/or is used to perform the grouping operation on a basis of a sub grouping rule, the sub grouping rule being with regulation that, when one original sentence begins with a target element noun which is a previously-defined element noun, and the target element noun has been defined in another original sentence defined ahead of said one original sentence, said another original sentence being begun with a first defined element noun, such that a position of the target element noun is determined as a beginning position of a group.

3. The claim resolving device as claimed in claim 1, wherein the sub grouping rule regulates that, when one original sentence is found with the grouping word defined in the grouping library, the grouping module determines whether the grouping word in said one original sentence is followed by one previously-defined element noun such that the previously-defined element noun is determined as a target element noun, and then a dividing position of the target element noun is determined when the target element noun is defined as a first-time-defined element noun in a beginning of another original sentence defined ahead of said one original sentence such that the dividing position of the target element noun is used as a beginning of a group.

4. The claim resolving device as claimed in claim 1, wherein the grouping module includes an element-noun-storing sub-module that stores all element nouns defined in beginning of the original sentences so as to use for the determination in the sub grouping rule.

5. The claim resolving device as claimed in claim 1, wherein the dividing rule is used to divide the element noun and the interrelationship definition defined after the element noun in the same original sentence.

6. The claim resolving device as claimed in claim 1, further comprising a subordinating module that, when a subordinating word defined in a subordinating library is identified, it subordinates a firstly defined element noun defined in beginning of the original sentence after the subordinating word such that the subordinated firstly defined element noun is taken as a subordinated element noun.

7. The claim resolving device as claimed in claim 6, further comprising a subordinated element noun counting module that counts the number of the subordinating word in the sectional block so as to determine times that the subordinating module is to be performed.

8. The claim resolving device as claimed in claim 1, further comprising a displaying level determining module that determines a level position of the element noun according to the dividing rule and/or the grouping rule and/or the subordinating rule.

9. The claim resolving device as claimed in claim 6, further comprising a displaying level determining module that determines a level position of the element noun according to the dividing rule and/or the grouping rule and/or the subordinating rule.

10. The claim resolving device as claimed in claim 8, further comprising a displaying module that displays the claim processed by the displaying level determining module according to a relationship of level position belonging to the element noun and the interrelationship definition corresponding to the element noun.

11. The claim resolving device as claimed in claim 9, further comprising a displaying module that displays the claim processed by the displaying level determining module according to a relationship of level position belonging to the element noun and the interrelationship definition corresponding to the element noun.

12. The claim resolving device as claimed in claim 10, wherein the displaying module uses the same marking expression to display the element noun and/or the interrelationship definition defined in the same level.

13. The claim resolving device as claimed in claim 11, wherein the displaying module uses the same marking expression to display the element noun and/or the interrelationship definition defined in the same level.

14. The claim resolving device as claimed in claim 10, wherein the displaying module uses different marking expressions to display the element noun and/or the interrelationship definition defined in different levels.

15. The claim resolving device as claimed in claim 11, wherein the displaying module uses different marking expressions to display the element noun and/or the interrelationship definition defined in different levels.
